(19) United States
(12) Patent Application Publication
(10) Pub. No.: US 2019/0098267 A1
(43) Pub. Date: Mar. 28, 2019

(54) HOLOLENS LIGHT ENGINE WITH LINEAR ARRAY IMAGERS AND MEMS

(71) Applicant: Microsoft Technology Licensing, LLC, Redmond, WA (US)

(72) Inventors: Yarn Chee POON, Sammamish, WA (US); Richard A. JAMES, Woodinville, WA (US); Jeb WU, Redmond, WA (US); Mark Louis Wilson O'HANLON, Woodinville, WA (US); Vijay Krishna PARUCHURU, Redmond, WA (US); Keita OKA, Bellevue, WA (US)

(21) Appl. No.: 15/717,709

(22) Filed: Sep. 27, 2017

(51) Int. Cl. H04N 9/31; G06T 19/00; G09G 3/00

(52) U.S. Cl. CPC H04N 9/3129; H04N 9/3155; H04N 9/3161; G09G 3/005; H04N 9/3173; G06T 19/006

(57) ABSTRACT

Features of the present disclosure implement a light illumination system that utilizes a scanning device that is pivotal on an axis between a plurality of positions. To this end, the system may partition the image frame into at least a first sub-image frame and a second sub-image frame. The system may adjust the scanning device, during the first time period, to a first position to reflect light associated with the first sub-image and adjust the scanning mirror, during the second time period, to a second position to reflect light associated with the second sub-image. Thus, by implementing the techniques described herein, the overall size of a linear array (e.g., liquid crystal on silicon or LCoS) in an optics systems (as well as of some optical components in the optics systems) may be reduced from its current constraints, and thereby achieving a compact optical system that is mobile and user friendly.

### BACKGROUND

The present disclosure relates to computer graphics systems, and more particularly, to presenting images on a display.

One area of computing devices that has grown in recent years is the area of virtual reality (VR) devices, which use a graphics processing unit (GPU) to render graphics from a computing device to a display device. Such technology may be incorporated into a head-mounted display (HMD) device in the form of eyeglasses, goggles, a helmet, a visor, or other eyewear. As used herein, a HMD device may include a device that generates and/or displays virtual reality images (e.g., from at least one virtual environment input), mixed reality (MR) images (e.g., from at least two virtual environment inputs), and/or augmented reality (AR) images (e.g., from at least one virtual environment input and one real environment input). In such devices, a scene produced on a display device can be oriented or modified based on user input (e.g., movement of a gamepad button or stick to cause movement of the orientation of the scene, introduction of items into the scene, etc.).

One challenge with incorporating display devices into HMD or mobile devices is the size constraints that limit some of the optical or display components that can be integrated into the HMD devices while miniaturizing the overall size of the HMD devices to improve user mobility. In recent years, digital projection systems using spatial light modulators, such as a digital micromirror device (hereafter “DMD”), transmissive liquid crystal display (hereafter “LCD”) and reflective liquid crystal on silicon (hereafter “LCoS”) have been receiving much attention as they provide a high standard of display performance. These displays offer advantages such as high resolution, a wide color gamut, high brightness and a high contrast ratio. However, such digital projection systems that rely on LCoS technology are also constrained with limits on the size of the optical components that may be reduced in the display system. Thus, there is a need in the art for improvements in presenting images on a display with miniaturized components without compromising the display quality or user experience.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

Features of the present disclosure implement a light illumination system that utilizes a scanning device (e.g., MEMs, Galvo, etc.) that may be pivotal on an axis between a plurality of positions. Each position of the scanning device may reflect light for a partial field of view image (e.g., subset of the full field of view image) into the waveguide. Thus, by implementing the techniques described herein, the overall size of the linear array LCoS in an optics systems (as well as of some optical components in the optics system) may be reduced from its current constraints, and thereby achieving a compact optical system that is mobile and user friendly.

One example implementation relates to a method for displaying an image frame on a display device. The method may include partitioning the image frame into a plurality of sub-image frames. The plurality of sub-image frames may include at least a first sub-image frame and a second sub-image frame. The method may further include generating, during a first time period, a first array of addressable pixels associated with a first sub-image frame. In some examples, the method may further include adjusting, during the first time period, a scanning device of the display device to a first position to reflect light associated with the first array of addressable pixels into the display device. The method may further include generating, during a second time period, a second array of addressable pixels associated with a second sub-image frame. The method may also include adjusting, during the second time period, the scanning device of the display device to a second position to reflect light associated with the second array of addressable pixels into the display device. As such, the method may include displaying an output of the display device to reproduce at least a portion of the image frame to a user. The output being a combination of the light associated with first array of addressable pixels of the first sub-image frame and the light associated with the second array of addressable pixels of the second sub-image frame.

Another example implementation relates to an image display device. The image display device may include a memory to store data and instructions, a processor in communication with the memory to execute instructions. The processor may execute instructions to partition the image frame into a plurality of sub-image frames. The plurality of sub-image frames may include at least a first sub-image frame and a second sub-image frame, and generating, during a first time period, a first array of addressable pixels associated with a first sub-image frame. In some examples, the processor may further execute instructions to adjust, during the first time period, a scanning device of the display device to a first position to reflect light associated with the first array of addressable pixels into a waveguide of the display device. The processor may further execute instructions to generate, during a second time period, a second array of addressable pixels associated with a second sub-image frame. The processor may further execute instructions to adjust, during the second time period, the scanning device of the display device to a second position to reflect light associated with the second array of addressable pixels into the display device. The processor may further execute instructions to display an output of the display device to reproduce at least a portion of the image frame to a user. The output being a combination of the light associated with first array of addressable pixels of the first sub-image frame and the light associated with the second array of addressable pixels of the second sub-image frame.

Another example implementation relates to a computer-readable medium having code executed by the processor for displaying an image frame on a display device. The code may further be executable by the processor for partitioning the image frame into a plurality of sub-image frames. The plurality of sub-image frames may include at least a first sub-image frame and a second sub-image frame, and generating, during a first time period, a first array of addressable pixels associated with the first sub-image frame. In some examples, the code may further be executable by the processor for adjusting, during the first time period, a scanning device of the display device to a first position to reflect light associated with the first array of addressable pixels into the display device. The code may further be executable by the processor for generating, during a second time period, a second array of addressable pixels associated with a second sub-image frame. The code may further be executable by the processor for adjusting, during the second time period, the scanning device of the display device to a second position to reflect light associated with the second array of addressable pixels into the display device. As such, the code may further be executable by the processor for displaying an output of the display device to reproduce at least a portion of the image frame to a user. The output being a combination of the light associated with first array of addressable pixels of the first sub-image frame and the light associated with the second array of addressable pixels of the second sub-image frame.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### DESCRIPTION OF THE FIGURES

The disclosed aspects of the present disclosure will hereinafter be described in conjunction with the appended drawings, provided to illustrate and not to limit the disclosed aspects, wherein like designations denote like elements, where a dashed line may indicate an optional component, and in which:

FIGS. 1A and 1B are a schematic diagram of a HMD device in accordance with an implementation of the present disclosure;

FIG. 2 is a schematic diagram of optics and a display panel of a head mounted display for displaying virtual reality images in accordance with an implementation of the present disclosure;

FIG. 3 is a flow chart of a method for displaying virtual reality images in accordance with an implementation of the present disclosure; and

FIG. 4 is a schematic block diagram of an example device in accordance with an implementation of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The present disclosure provides devices and methods for presentation of images such as virtual reality (VR) or augmented reality (AR) images on a display that is incorporated into mobile display devices, such as displays implemented for HMD. It should be appreciated by those of ordinary skill in the art that while the present disclosure references HMD, the display techniques implemented herein may be adaptable for any mobile device, including but not limited to, mobile phones, tablets, or laptops.

As discussed above, one challenge with incorporating display devices into mobile devices is the size constraints that limit the components that can be integrated into the display systems while miniaturizing the overall size of the HMD devices or mobile display to improve user mobility. Some systems using LCoS technology limit the size of the optical components (i.e., how small of the optical components) that can be implemented in the display system without compromising image quality.

Specifically, linear array LCoS that generate an image for display are larger in size because they are tasked with generating pixels for full resolution image for the full field of view that would be visible to the user's eye. Because the linear array LCoS may be tasked with generating the full array of addressable pixels for an image for the full field of view in single row, the optics of the HMD may be limited in the size reductions that can be realized because the size of the optics required to process the images correlate to the size of the imager (e.g., linear array LCoS) that generates the image for display.

Features of the present disclosure solve this problem by implementing a light illumination system (one or both of coherent light and/or incoherent light source) that utilizes a scanning mirror that is pivotal on a plane between a plurality of positions (e.g., position A and position B) where the scanning may be one or both of vertical scanning and/or horizontal scanning of the scanning mirror. Specifically, the scanning device (e.g., MEMs, Galvo, etc.) allows for a smaller optical components because instead of reproducing the entire image at once as provided by current systems, the scanning device allows for smaller portions of the image to be reproduced and combined to provide the full image. In doing so, the optical components size utilized may be reduced, thereby reducing the size of the overall system such as HMD. In some examples, the scanning device may be adjusted either one or both of vertical positions or horizontal positions (e.g., vertical and/or horizontal scanning). It should also be appreciated that the adjustment of the scanning mirror is not limited to two positions (e.g., position A and position B), but may include any number of positions.

Thus, in some examples, each position of the scanning device (e.g., MEMs, Galvo, etc.) may reflect light for a partial field of view image (e.g., subset of the full field of view image) into the waveguide to display to user. The term “waveguide” may refer to devices, including but not limited to, surface relief gratings, reflective prisms, pupil expanding devices, pupil relaying devices, or any device that may be used to display images to the user. In some examples, the scanning device may also operate with or without a waveguide such that the image(s) generated for display may be projected directly into the user's eye without the need for a waveguide. The display device may also include, but is not limited to DLPS and LCoS. For example, a full image to be displayed onto the waveguide may be split into two halves (or more): the first portion and the second portion. In such instance, the linear array LCoS, during the first time period, may generate a first half of the image that is reflected into the waveguide by positioning the scanning mirror to the first scanning position. During the second time period, the linear array LCoS may generate the second half of the image that is reflected into the waveguide by positioning the scanning mirror to the second scanning position. As such, because the linear array LCoS is not tasked with generating the full resolution image for the full field of view at each instance, the overall size of the linear array LCoS may be reduced such that the linear array LCoS produces half the image at each time period. In addition, aspects of the present disclosure are not limited to only laser light source (i.e., coherent light), but are adaptable to incoherent light source (e.g., LED illumination) that can propagate in the waveguide of the image display device. The term “incoherent light” (e.g., LED light) refers to light where each individual light wave is not uniformly aligned with one another.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

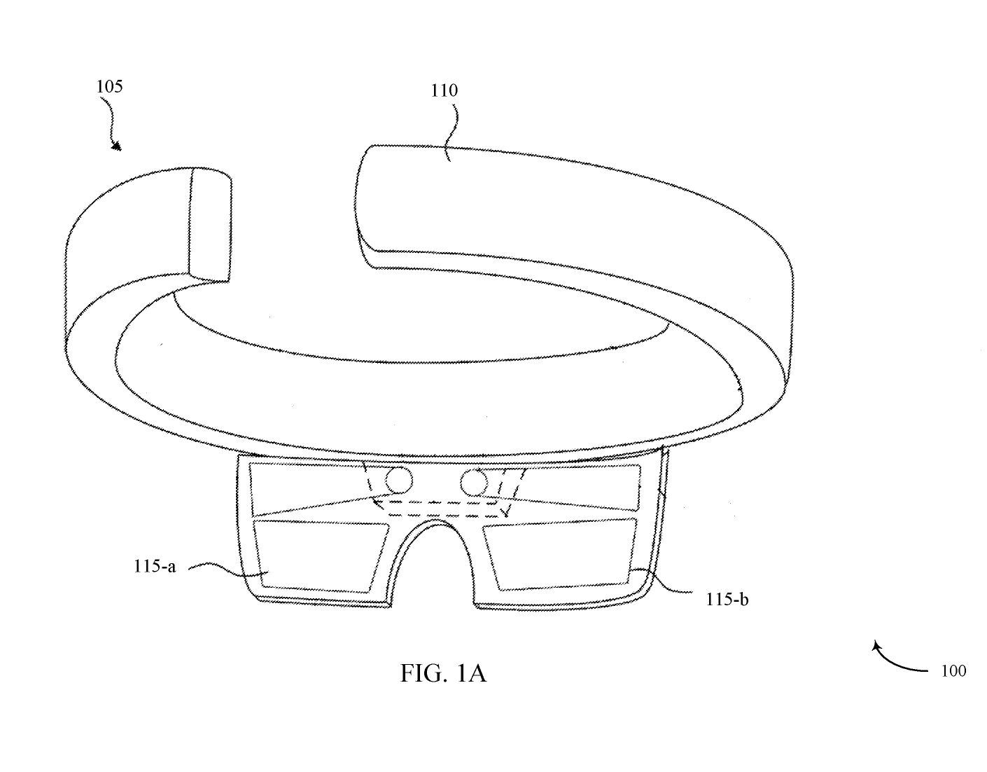

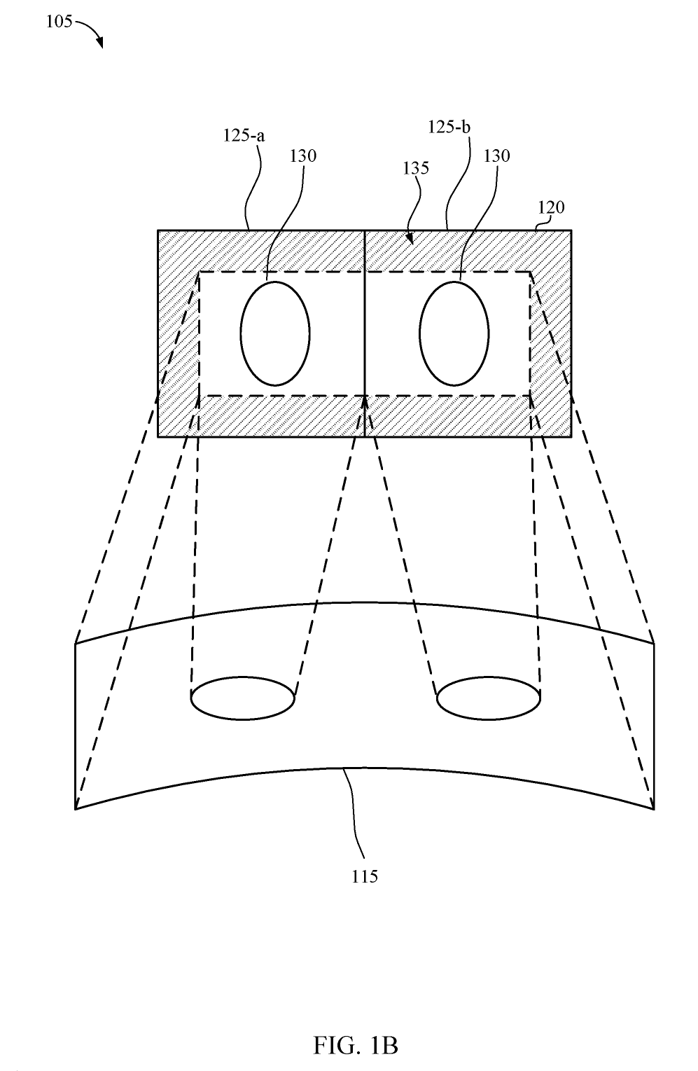

Turning first to FIGS. 1A and 1B, a display device 100, such as an HMD 105, is illustrated that may implement display techniques in accordance with an present disclosure. For purposes of the disclosure, features of FIGS. 1A and 1B will be discussed concurrently.

A HMD device 105 may be configured to provide virtual reality images (e.g., from at least one virtual environment input), mixed reality (MR) images (e.g., from at least two virtual environment inputs), and/or augmented reality (AR) images. The HMD 105 comprises a headpiece 110, which may be a headband, arranged to be worn on the user's head. It should be appreciated by those of ordinary skill in the art that the HMD 100 may also be attached to the users head using a frame (in the manner of conventional spectacles), helmet or other fit system. The purpose of the fit system is to support the display and provide stability to the display and other head borne systems such as tracking systems and cameras.

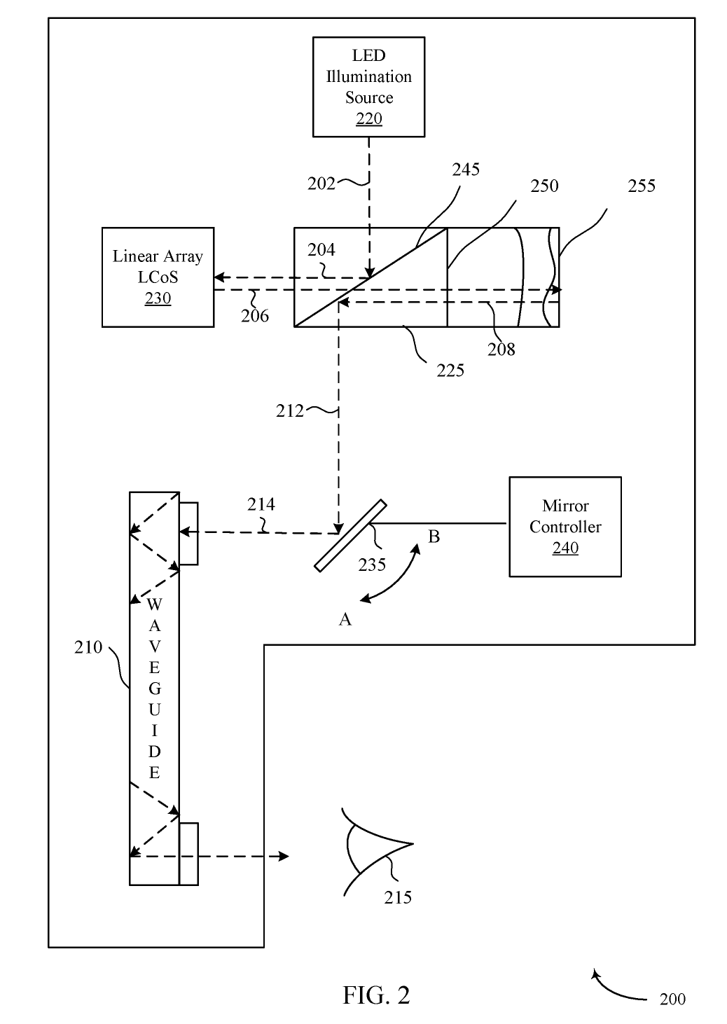

The HMD 105 may include optical components 115 (e.g., one or more lenses), including waveguides that may allow the HMD 105 to project images generated by a light engine. The optical components 115 may use plate-shaped (usually planar) waveguides for transmitting angular image information to users' eyes as virtual images from image sources (e.g., light engine) located out of the user's line of sight. The image information may be input near one end of the waveguides and is output near another end of the waveguides (see FIG. 2). The image information may propagate along the waveguides as a plurality of angularly related beams that are internally reflected along the waveguide. Diffractive optics are often used for injecting the image information into the waveguides through a first range of incidence angles that are internally reflected by the waveguides as well as for ejecting the image information through a corresponding range of lower incidence angles for relaying or otherwise forming an exit pupil behind the waveguides in a position that can be aligned with the users' eyes. Both the waveguides and the diffractive optics at the output end of the waveguides may be at least partially transparent so that the user can also view the ambient environment through the waveguides, such as when the image information is not being conveyed by the waveguides or when the image information does not fill the entire field of view.

The light engine (not shown), that may project images to be displayed on the optical components 115, may comprise a micro display and imaging optics in the form of a collimating lens. The micro display can be any type of image source, such as liquid crystal on silicon (LCoS) displays, liquid crystal displays (LCD), matrix arrays of LED's (whether organic or inorganic) and any other suitable display. The optical components 115 may focus a user's vision on one or more portions of one or more display panels 120, as shown in FIG. 1B. The display panels 120 may display one or more images (e.g., left eye image 125-a and right eye image 125-b) based on signals received from the light engine. The optics 115 may include left eye optics 115-a for focusing the user's left eye on the left eye image 125-a and right eye optics 115-b for focusing the user's right eye on the right eye image 125-b. For example, the optics 115 may focus the user's eyes on a central portion of each of the left eye image 125-a and the right eye image 125-b. The user's brain may combine the images viewed by each eye to create the perception that the user is viewing a 3D environment. For example, both the left eye image 125-a and the right eye image 125-b may include an object 130 that may be perceived as a three dimensional object. In some examples, a border portion 135 of the left eye image 125-a and right eye image 125-b may be displayed by the display panel 120, but may not be visible to the user due to the optics 115.

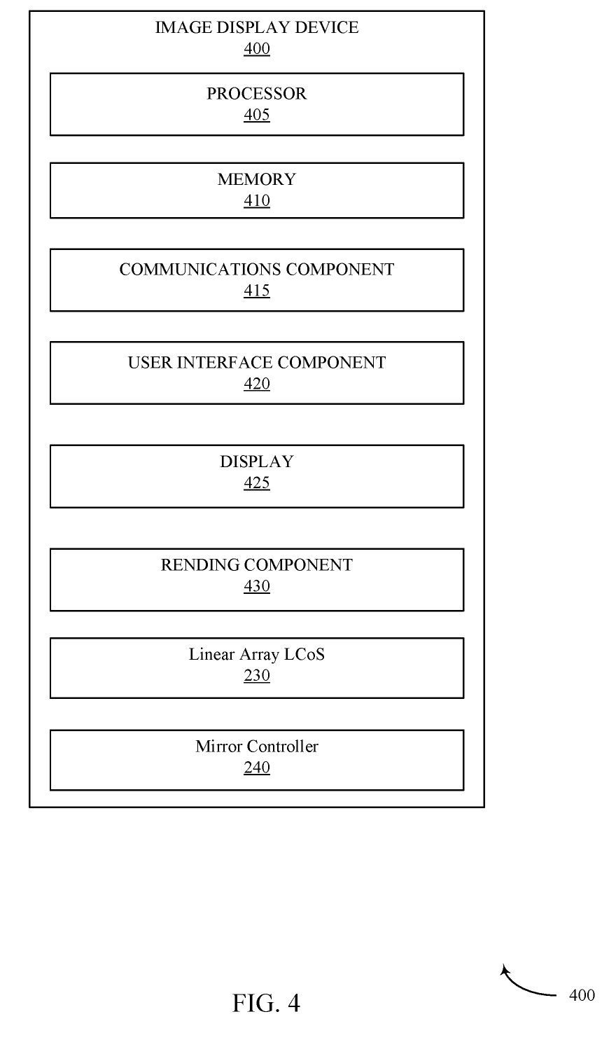

Though not shown in FIGS. 1A and 1B, a processing apparatus 405, memory 410 and other components may be integrated into the HMD 105 (see FIG. 4). Alternatively, such components may be housed in a separate housing connected to the HMD 105 by wired and/or wireless means. For example, the components may be housed in a separate computer device (e.g., smartphone, tablet, laptop or desktop computer etc.) which communicates with the display device 100. Accordingly, mounted to or inside the HMD 105 may be an image source, such as a micro display for projecting a virtual image onto the optical component 115. As discussed above, the optical component 115 may be a collimating lens through which the micro display projects an image.

FIG. 2 illustrates a light illumination system 200 that may be implemented for an optical components 115 for the HMD 105 to project images generated by an image source (not shown) and illuminated by the LED illumination source 220 onto a waveguide 210 for projection into a user's eye 215. In some examples, the image(s) to be displayed may be input from the image source to the linear array LCoS 230 that generates addressable array of pixels associated with the image to be projected. Once the linear array LCoS 230 generates the addressable pixels associated with the image, an LED illumination source 220 may reflect light 202 from a polarizing beam splitter 245 to the linear array LCoS 230 such that light associated with the addressable pixels is reflected on the waveguide 210.

The waveguide 210 can be either a hollow pipe with reflective inner surfaces or an integrator rod with total or partial internal reflection. In either instance, the waveguide 210 may include an inside surface (facing the users eye) and an outside surface (facing the ambient environment), with both the inside and outside surfaces and being exposed to air or another lower refractive index medium. As such the waveguide 210 may be at least partially transparent so that the user can also view the ambient environment through the waveguide 210.

The light illumination system 200 may include an LED illumination source 220 that may be LED light source, an RGB LED source (e.g. an LED array) for producing images to be projected onto the waveguide 210 on the HMD 105. As noted above, the LED illumination source 220 may provide an incoherent light where each individual light wave does not align with each other. In contrast, laser lights are coherent light source that allows for each individual wave to be uniform. The LED illumination source 220 may be coupled to an illumination facility 225 that may receive and redirect the light that forms the image to the waveguide 210 through an interference grating, scattering features, reflective surfaces, refractive elements, and the like. For example, the LED illumination source 220 may produce an LED light to be reflected to the linear array LCoS 230 such that the image to be displayed is rendered by the linear array LCoS 230 using addressable pixels and propagated to the waveguide 210.

For example, the LED light 202 may enter the illumination facility 225 and be redirected 204 by the polarizing beam splitter 245 to the linear array LCoS 230 that generate an array of addressable pixels that form a real image projected onto the waveguide 210. The light 206 is then reflected from the LCoS 230 back through the polarizing beam splitter 245 and the quarterwave retarder 250 to be reflected 208 off mirror from the lens 255 back into the polarizing beam splitter 245. The polaziring beam splitter 245 again redirects the light 212 ninety degrees onto the scanning device 235 that may pivot on axis between a plurality of positions. The light 214 thereafter reflect from the scanning device 235 to enter a waveguide 210 where the light is propagated down the waveguide 210 before being directed towards the user's eye 215.

As discussed, the light illumination system 200 may include a linear array LCoS 230 for generating an array of addressable pixels that form a real image projected onto the waveguide 210. Typical linear array LCoS 230 are larger in size because they are tasked with generating full resolution image for the full field of view that would be visible to the user's eye 215. For example, in order to support a 28 degree field of view at full resolution, the linear array LCoS 230 may generate a 2,000 pixel horizontal and 1,200 pixel vertical image. Because the linear array LCoS 230 may be tasked with generating the full resolution image for the full field of view in single row, the optics component 115 of the HMD 105 may be limited to the size reductions that can be realized for the optics component 115.

Features of the present disclosure solve this problem by implementing a light illumination system 200 that utilizes a scanning device 235 that is pivotal on a plane between a plurality of positions (e.g., position A and position B). Each position of the scanning device 235 may reflect light for a partial field of view image (e.g., subset of the full field of view image) into the waveguide 210. For example, a full image to be displayed onto the waveguide 210 may be split into two halves: the first portion and the second portion. In such instance, the linear array LCoS 230, during the first time period, may generate a first half of the image that is reflected into the waveguide 210 by positioning the scanning device 235 to the first scanning position. During the second time period, the linear array LCoS 230 may generate the second half of the image that is reflected into the waveguide 210 by positioning the scanning device 235 to the second scanning position. As such, because the linear array LCoS 230 is not tasked with generating the full resolution image for the full field of view at each instance, the overall size of the linear array LCoS 230 may be reduced such that the linear array LCoS 230 produces half the image at each time period.

In order to prevent the user from recognizing that only half an image is being generated at each instance, the mirror controller 240 may switch or alternative the scanning device 235 between a plurality of scanning positions at a clock rate that compensates for the partial image generation. For example, if an image frame rate is 60 Hz (e.g., 60 frames per second), the scanning device 235 may operate at a 120 Hz such that the user's eye 215 preserves the complete the image on the waveguide 210 even when the image display device, at any one instance, is only projecting a portion of the image (i.e., sub-image). This is because a human eye cannot observe greater than 60 Hz image rate. Thus, by dynamically switching the scanning device 235 between a plurality of scanning positions at a rate that may be faster than image frame rate (i.e., 60 Hz image frame rate associated with two positions would require the scanning device 235 to operate at 120 Hz to achieve the same perceived image), features of the present disclosure are able to reduce the size of the linear array LCoS while maintaining same rendering quality. In some examples, the scanning device 235 may be a MEMs-based mirror, and in turn the mirror controller 240 may be a MEMs-based mirror controller.

Although the above example is described with reference to dividing the image into two halves (and thus two positions for the scanning device 235), it should be appreciated that the size of the linear array LCoS 230 may be further reduced by subdividing the image further. For example, the linear array LCoS 230 may subdivide an image to be displayed into three parts (e.g., one-third image of the full image). In such instance, the linear array LCoS 230 may generate a first portion of the image that is one-third of the full image. The mirror controller 240 may adjust the scanning device to the first position during the first time period to reflect the light corresponding to the first portion of image. During the second time period, the linear array LCoS 230 may generate the second portion of the image that is reflected into the waveguide 210 by adjusting the scanning device 235 to the second position. By extension, during the third time period, the linear array LCoS 230 may generate the third portion of the image that is reflected into the waveguide 210 by adjusting the scanning device 235 to the third position. In such instance, in order to avoid degrading the user experience, the 60 Hz image frame may require the mirror controller 240 to operate the scanning device 235 at 180 Hz to ensure that the user's eye 215 fails to recognize that at each instance of time, only part of the full image is being displayed.

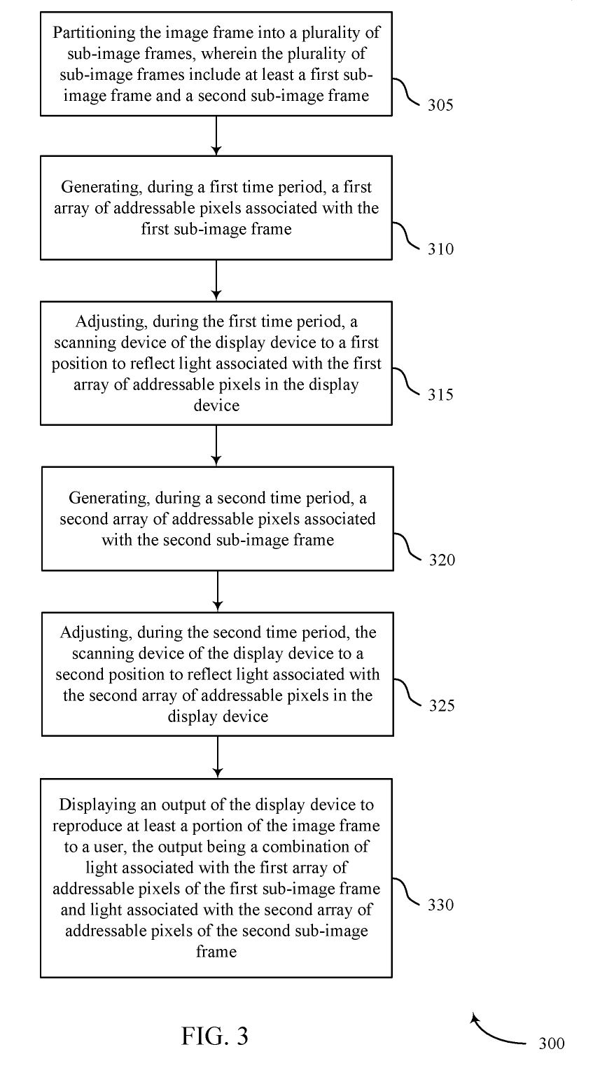

Turning next to FIG. 3, method 300 for displaying an image frame on a display device is described. The method 300 may be performed by the light illumination system 200 as described with reference to FIG. 2. As discussed above, the features of the method 300 may be incorporated not only in the HMD 105 technology, but also other display devices such as mobile phones, tablets, or laptops. Although the method 300 is described below with respect to the elements of the light illumination system of the display device, other components may be used to implement one or more of the steps described herein.

At block 305, the method 300 may include partitioning an image frame into a plurality of sub-image frames. The plurality of sub-image frames include at least a first sub-image frame and a second sub-image frame. While the example herein is described with reference to a first sub-image frame and the second sub-image frame, the display device may partition the image frame into any number of sub-image frame(s) (e.g., three, four, five, etc.). The image frame may be generated by an image source device to be rendered on an optical component of the a display device (e.g., waveguide of the HMD, surface relief gratings, reflective prisms, pupil expanding devices, pupil relaying devices, or any device that may be used to display images to the user.). The image frame may be one or more of virtual reality image from at least one virtual environment input, mixed reality images from at least two virtual environment inputs, or an augmented reality image. It should be appreciate by those of ordinary skill in the art that the image frame may be partitioned into even further sub-image frame(s) that correspond to the plurality of positions for the scanning device. Aspects of block 305 may be performed by the rendering component 430 described with reference to FIG. 4.

At block 310, the method 300 may include generating, during a first time period, a first array of addressable pixels associated with the first sub-image frame. The first array of addressable pixels may be generated by a spatial light modulators, such as a digital micromirror device, transmissive liquid crystal display (hereafter “LCD”) or reflective liquid crystal on silicon (LCoS). Aspects of block 305 may be performed by linear array LCoS 230 described with reference to FIGS. 2 and 4.

At block 315, the method 300 may include adjusting, during the first time period, a scanning device (e.g., scanning MEMs mirror or any scanner to reflect light) of the display device to a first position to reflect light associated with the first array of addressable pixels into a waveguide of the display device. In some examples, the mirror controller 240 may dynamically adjust the position of the scanning device 235 on an axis from a plurality of available positions.

At block 320, the method 300 may include generating, during a second time period, a second array of addressable pixels associated with the second sub-image frame. The second array of addressable pixels may also be generated by a spatial light modulators described above. Aspects of block 320 may be performed by linear array LCoS 230 described with reference to FIGS. 2 and 4.

At block 325, the method 300 may include adjusting, during the second time period, the scanning device of the display device to a second position to reflect light associated with the second array of addressable pixels into the display device. In some examples, the scanning device alternates between the first position and the second position at a clock rate that is faster than frame rate of the image frame. For example, if the image frame rate is 60 Hz (60 frames per second), the scanning device may alternative between the plurality of positions at a rate of 120 Hz if the image frame is sub-divided into two halves. If the image frame is further subdivided (e.g., in four sub-images, where each image is a quarter of the full image) where the image frame rate is 60 Hz, the scanning device will alternate between the plurality of positions (e.g., first position, second position, third position, and fourth position) at a rate of 240 Hz. Aspects of block 320 may be performed by the mirror controller 240 that may dynamically adjust the position of the scanning device 235 on an axis from a plurality of available positions.

At block 330, the method 300 may include displaying an output of the display device (e.g., output of the waveguide or projection directly into user's eye) to reproduce at least a portion of the image frame to a user. The output may be a combination of light associated with the first array of addressable pixels of the first sub-image frame and light associated with the second array of addressable pixels of the second sub-image frame. In some examples, the first array of addressable pixels and the second array of addressable pixels may be illuminated by a LED illumination source 220 with an incoherent light and/or coherent light. Aspects of block 320 may be performed by display 425 described with reference to FIG. 4.

Referring now to FIG. 4, a diagram illustrating an example of a hardware implementation for displaying an image frame on a display device (e.g., HMD) in accordance with various aspects of the present disclosure is described. In some examples, the image display device 400 may be an example of the HMD 105 described with reference to FIGS. 1A and 1B.

The image display device 400 may include a processor 405 for carrying out one or more processing functions (e.g., method 300) described herein. The processor 405 may include a single or multiple set of processors or multi-core processors. Moreover, the processor 405 can be implemented as an integrated processing system and/or a distributed processing system.

The image display device 405 may further include memory 410, such as for storing local versions of applications being executed by the processor 405. In some aspects, the memory 410 may be implemented as a single memory or partitioned memory. In some examples, the operations of the memory 410 may be managed by the processor 405. Memory 410 can include a type of memory usable by a computer, such as random access memory (RAM), read only memory (ROM), tapes, magnetic discs, optical discs, volatile memory, non-volatile memory, and any combination thereof. Additionally, the processor 405, and memory 410 may include and execute operating system (not shown).

Further, apparatus 105 may include a communications component 415 that provides for establishing and maintaining communications with one or more parties utilizing hardware, software, and services as described herein. Communications component 415 may carry communications between components on image display device 405. The communications component 415 may also facilitate communications with external devices to the image display device 405, such as to electronic devices coupled locally to the image display device 405 and/or located across a communications network and/or devices serially or locally connected to apparatus 105. For example, communications component 415 may include one or more buses operable for interfacing with external devices. In some examples, communications component 415 establish real-time video communication events such as real-time video calls, instant messaging sessions, screen sharing or whiteboard sessions, etc., via the network, with another user(s) of the communication system operating their own devices running their own version of the communication client software in order to facilitate augmented reality.

The image display device 405 may also include a user interface component 420 operable to receive inputs from a user of display device 105 and further operable to generate outputs for presentation to the user. User interface component 420 may include one or more input devices, including but not limited to a navigation key, a function key, a microphone, a voice recognition component, joystick or any other mechanism capable of receiving an input from a user, or any combination thereof. Further, user interface component 420 may include one or more output devices, including but not limited to a speaker, headphones, or any other mechanism capable of presenting an output to a user, or any combination thereof.

The image display device 405 may include a rendering component 430 that controls the light engine(s) to generate an image visible to the wearer of the HMD, i.e. to generate slightly different 2D or 3D images that are projected onto the waveguide so as to create the impression of 3D structure.

The image display device 405 may further include a display 425 that may be an example of the optics 115 or waveguide 210 described with reference to FIGS. 1A, 1B and 2. The image display device 405 may also include linear array LCoS 230 that may generate an array of pixels associated with the image frame. Additionally, the image display device 405 may also include a mirror controller 240 that may dynamically adjust the scanning device (see FIG. 2) of the image display device to multiple positions to reflect image light associated with a partial field of view of the full image frame.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a device, which can be a wired device or a wireless device. A wireless device may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. In contract, a wired device may include a server operable in a data centers (e.g., cloud computing).

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It should be appreciated to those of ordinary skill that various aspects or features are presented in terms of systems that may include a number of devices, components, modules, and the like. It is to be understood and appreciated that the various systems may include additional devices, components, modules, etc. and/or may not include all of the devices, components, modules etc. discussed in connection with the figures.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave may be included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While aspects of the present disclosure have been described in connection with examples thereof, it will be understood by those skilled in the art that variations and modifications of the aspects described above may be made without departing from the scope hereof. Other aspects will be apparent to those skilled in the art from a consideration of the specification or from a practice in accordance with aspects disclosed herein.

What is claimed is:

1. A method for displaying an image frame on a display device, comprising:
partitioning the image frame into a plurality of sub-image frames, wherein the plurality of sub-image frames include at least a first sub-image frame and a second sub-image frame;
generating, during a first time period, a first array of addressable pixels associated with the first sub-image frame;
adjusting, during the first time period, a scanning device of the display device to a first position to reflect light associated with the first array of addressable pixels in the display device;
generating, during a second time period, a second array of addressable pixels associated with the second sub-image frame;
adjusting, during the second time period, the scanning device of the display device to a second position to reflect light associated with the second array of addressable pixels in of the display device; and
displaying an output of the display device to reproduce at least a portion of the image frame to a user, the output being a combination of the light associated with the first array of addressable pixels of the first sub-image frame and the light associated with the second array of addressable pixels of the second sub-image frame.

2. The method of claim 1, further comprising:
alternating the scanning device between the first position and the second position at a clock rate that is faster than an image frame rate of the image frame.

3. The method of claim 2, wherein the clock rate of the scanning device alternating between the first position and the second position is twice the image frame rate.

4. The method of claim 1, wherein the first array of addressable pixels and the second array of addressable pixels are illuminated by an illumination source with an incoherent light or a coherent light.

5. The method of claim 1, wherein the image frame is one or more of a virtual reality image from at least one virtual environment input, mixed reality images from at least two virtual environment inputs, or an augmented reality image.

6. The method of claim 1, wherein the display device is a head-mounted display (HMD) device configured to display the image frame.

7. The method of claim 1, wherein the first and the second array of addressable pixels are generated by a spatial light modulator.

8. An display device, comprising:
a processor; and
a memory, coupled to the processor, and storing instructions that are executable by the processor to:
partition the image frame into a plurality of sub-image frames, wherein the plurality of sub-image frames include at least a first sub-image frame and a second sub-image frame;
generate, during a first time period, a first array of addressable pixels associated with the first sub-image frame;
adjust, during the first time period, a scanning device of the display device to a first position to reflect light associated with the first array of addressable pixels into the display device;
generate, during a second time period, a second array of addressable pixels associated with the second sub-image frame;
adjust, during the second time period, the scanning device of the display device to a second position to reflect light associated with the second array of addressable pixels into the display device; and
display an output of the display device to reproduce at least a portion of the image frame to a user, the output being a combination of the light associated with the first array of addressable pixels of the first sub-image frame and the light associated with the second array of addressable pixels of the second sub-image frame.

9. The display device of claim 8, wherein the instructions are further executable by the processor to:
alternate the scanning device between the first position and the second position at a clock rate that is faster than an image frame rate of the image frame.

10. The display device of claim 9, wherein the clock rate of the scanning device alternating between the first position and the second position is twice the image frame rate.

11. The display device of claim 8, wherein the first array of addressable pixels and the second array of addressable pixels are illuminated by an illumination source with an incoherent light or a coherent light.

12. The display device of claim 8, wherein the image frame is one or more of a virtual reality image from at least one virtual environment input, mixed reality images from at least two virtual environment inputs, or an augmented reality image.

13. The display device of claim 8, wherein the display device is a head-mounted display (HMD) device configured to display the image frames.

14. The display device of claim 8, wherein the first and the second array of addressable pixels are generated by a spatial light modulator.

15. A computer-readable medium storing code that is executable by a processor, the code including instructions for:
partitioning the image frame into a plurality of sub-image frames, wherein the plurality of sub-image frames include at least a first sub-image frame and a second sub-image frame;
generating, during a first time period, a first array of addressable pixels associated with the first sub-image frame;
adjusting, during the first time period, a scanning device of the display device to a first position to reflect light associated with the first array of addressable pixels into the display device;
generating, during a second time period, a second array of addressable pixels associated with the second sub-image frame;
adjusting, during the second time period, the scanning device of the display device to a second position to reflect light associated with the second array of addressable pixels into of the display device; and
displaying an output of the display device to reproduce at least a portion of the image frame to a user, the output being a combination of the light associated with the first array of addressable pixels of the first sub-image frame and the light associated with the second array of addressable pixels of the second sub-image frame.

16. The computer readable medium of claim 15, wherein the code further includes instructions for:
alternating the scanning device alternates between the first position and the second position at a clock rate that is faster than an image frame rate of the image frame.

17. The computer readable medium of claim 16, wherein the clock rate of the scanning device alternating between the first position and the second position is twice the image frame rate.

18. The computer readable medium of claim 15, wherein the first array of addressable pixels and the second array of addressable pixels are illuminated by an illumination source with an incoherent light or a coherent light.

19. The computer readable medium of claim 15, wherein the image frame is one or more of a virtual reality image from at least one virtual environment input, mixed reality images from at least two virtual environment inputs, or an augmented reality image.

20. The computer readable medium of claim 15, wherein the display device is a head-mounted display (HMD) device configured to display the image frames.
